(19) United States
(12) Patent Application Publication
(10) Pub. No.: US 2010/0053165 A1
(43) Pub. Date: Mar. 4, 2010

(54) IMAGE ADJUSTING SYSTEM AND METHOD

(75) Inventors: XIAO-GUANG LI, Shenzhen City (CN); TE-YUAN KUNG, Tu-Cheng (TW); LI-ZHANG HUANG, Tu-Cheng (TW); ZAI-AN PAN, Shenzhen City (CN); XIAO-FANG CHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/257,357

(22) Filed: Oct. 23, 2008

(30) Foreign Application Priority Data
Sep. 3, 2008 (CN) 200810304359.2

(51) Int. Cl. G06T 17/00

(52) U.S. Cl. 345/428

(57) ABSTRACT

An image adjusting method includes supplying an adjusting device connected with a display device; receiving an adjusting request including a source location, a target location and a revolution of the display device from the display device; obtaining the source location, the target location and the revolution of the display device from the adjusting request, and images from the source location; reducing the resolution of the obtained image according to the resolution of the display device when a revolution of the obtained image is not consistent with the revolution of the display device; and storing the adjusted desired image to the target location. A display device and an adjusting device are also provided.

### BACKGROUND

1. Technical Field

The present invention relates to a display device, an image adjusting device and an image adjusting method that adjusts revolutions of images according to a revolution of the display device.

2. General Background

A display device (e.g. a digital photo frame) can only display images adapted to its resolution, and many display devices have low resolutions. Advances in camera technology have led to high resolution of captured images. High resolution of images and low resolution of display images cause a waste of memory capacity.

US publication application 2005/0135790, hereby incorporated by reference, discloses a method for reducing resolution of images to be commensurate with a display device for displaying the images. But many display devices can not manipulated as easily and quickly as a computer.

What is needed, therefore, is an image adjusting device and a method that adjust revolutions of images according to a revolution of the display device more easily and quickly.

### BRIEF DESCRIPTION OF THE DRAWINGS

The components of the drawings are not necessarily drawn to scale, the emphasis instead being placed upon clearly illustrating the principles of the image adjusting method that adjusts revolution of images according to a revolution of a display device. Moreover, in the drawings, like reference numerals designate corresponding parts throughout the several views.

FIG. 1 is an exemplary block diagram for a hardware infrastructure of an image adjusting system in accordance with an exemplary embodiment, the image adjusting system including a display device and an adjusting device.

FIG. 2 is flowchart depicting an image adjusting method implemented by the display device of FIG. 1 in accordance with an exemplary embodiment.

FIG. 3 is flowchart depicting the image adjusting method implemented by the adjusting device of FIG. 1 in accordance with an exemplary embodiment.

### DETAILED DESCRIPTION OF THE EMBODIMENTS

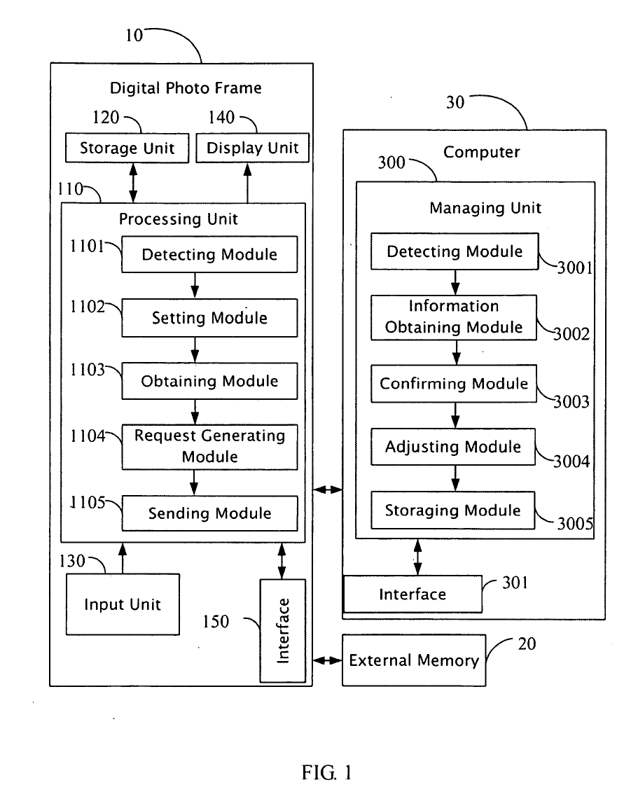

FIG. 1 is an exemplary block diagram for a hardware infrastructure of an image adjusting system with an adjusting function. The image adjusting system includes a display device 10, an external memory 20, and an adjusting device 30. The display device 10 is configured for displaying images, the external memory 20 is connected with the display device 10 via an interface 150 of the display device 10, and the adjusting device 30 is configured for adjusting images. For illustrative purpose, in the exemplary embodiment, the display device 10 takes a digital photo frame for example, the external memory 20 takes a memory card for example, and the adjusting device 30 takes a computer for example. However, it should be noted that the display device 10, the external memory 20, and the adjusting device 30 are not limited to the examples illustrated in this disclosure.

The digital photo frame 10 includes a processing unit 110, a storage unit 120, an input unit 130, a display unit 140, and the interface 150. The storage unit 120 is configured for storing images. The input unit 130 is configured for receiving a user's input, and sending a corresponding operation signal to the processing unit 110. The display unit 140 is configured for displaying images.

The processing unit 110 is configured for obtaining an desired image from the storage unit 120 or the external memory 20 according to the operation signal generated by the input unit 130, and displaying the desired image on the display unit 140. The processing unit 110 is further configured for adjusting the desired image according to the user's operation, for example, rotation, zooming, and saving.

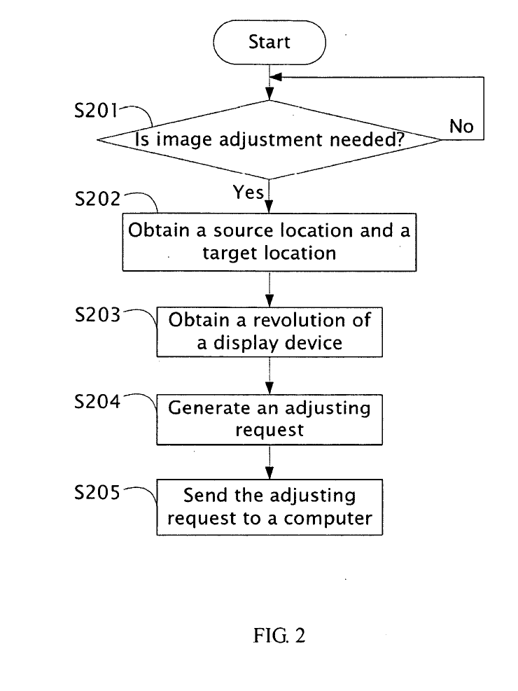

The processing unit 110 includes a detecting module 1101, a setting module 1102, an obtaining module 1103, a request generating module 1104, and a sending module 1105. The functions of the modules in the processing unit 110 are described below together with FIG. 2.

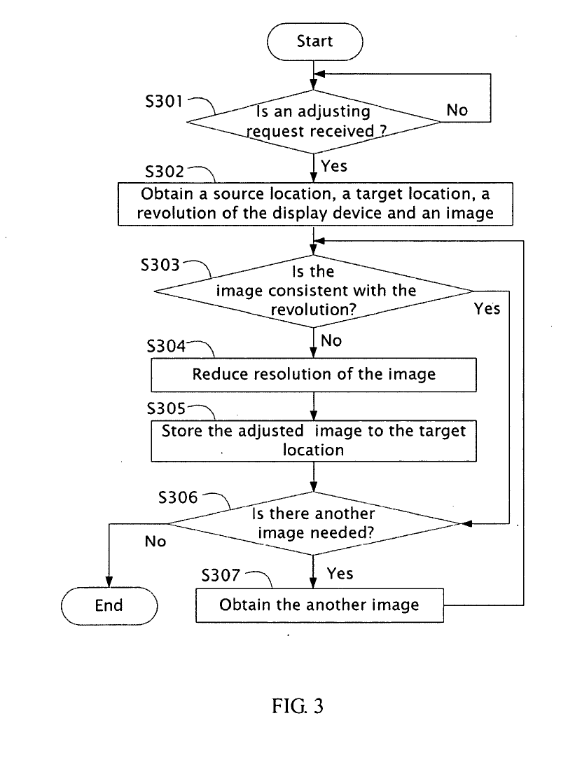

The computer 30 is connected with the digital photo frame 10 via the interface 150 of the digital photo frame 10 and an interface 301 of the computer 30, and thereby receives signals from the digital photo frame 10. The computer 30 further includes a managing unit 300. The managing unit 300 is configured for performing functions according to the received signals. The managing unit 300 includes a detecting module 3001, an information obtaining module 3002, a confirming module 3003, an adjusting module 3004, and a storing module 3005. The functions of the modules in the managing unit 300 are described below together with FIG. 3.

The managing unit 300 is run by a program. The program can be preinstalled in the computer 30. The program can also be stored in the storage unit 120 of the digital photo frame 10. When the digital photo frame 10 is connected with the computer 30, the program is automatically installed to the computer 30 from the digital photo frame 10. The computer 30 executes the program, and thus to perform the function of the managing unit 300.

FIG. 2 is flowchart depicting an image adjusting method implemented by the display device of FIG. 1. Depending on the embodiment, certain steps described below may be removed, others may be added, and the sequence of steps may be altered.

In step S201, the detecting module 1101 detects whether the operation signal for adjusting images generated from the input unit 130 is received.

In step S202, if the operation signal for adjusting images is received, the obtaining module 1103 obtains a source location and a target location of desired images needed to be adjusted. The source location is a location where desired images that needed to be adjusted are located. The source location may be, for example, the external memory 20 connected with the digital photo frame 10, or the storage unit 120 in the digital photo frame 10. The target location is another location where the adjusted desired images will be stored. The target location may be, for example, the external memory 20 connected with the digital photo frame 10, or the storage unit 120 in the digital photo frame 10. The source location and the target location may be set by the user via the setting module 1102, or may be provided by the system as system defaults.

In step S203, the obtaining module 1103 obtains the revolution of the digital photo frame 10.

In step S204, the request generating module 1104 generates an adjusting request. The adjusting request includes the source location, the target location, and the revolution of the display unit 140.

In step S205, the sending module 1105 sends the adjusting request to the computer 30 via the interface 150 of the digital photo frame 10.

FIG. 3 is flowchart depicting the image adjusting method implemented by the adjusting device of FIG. 1. Depending on the embodiment, certain steps described below may be removed, others may be added, and the sequence of steps may be altered.

In decision step S301, the detecting module 3001 determines whether the adjusting request is received from the digital photo frame 10. If the adjusting request is received from the digital photo frame 10, the method goes to step S302.

In step S302, the information obtaining module 3002 obtains the source location, the target location, and the revolution of the digital photo frame 10 from the adjusting request. Supposing that the external memory 20 is the source location and the storage unit 120 is the target location, the information obtaining module 3002 obtains an image needed from the external memory 20 according to a sorting criteria. The sorting criteria may be browsing time, file size, creation time of the images, and so on.

In decision step S303, the confirming module 3003 determines whether a revolution of the obtained image is consistent with the revolution of the digital photo frame 10. If the revolution of the obtained image is consistent with the revolution of the digital photo frame 10, the procedure moves to step S306. If the revolution of the obtained image is not consistent with the revolution of the digital photo frame 10, the procedure moves to step S304.

In step S304, the adjusting module 3004 reduces the resolution of the obtained image according to the resolution of the digital photo frame 10. Supposed that the resolution of the display unit 140 is 800×600 and the resolution of the obtained image is 2048×1536, as the resolution of 2048×1536 of the obtained image is larger than the resolution of 800×600 of the display unit 140, the adjusting module 3004 reduces the resolution of 2048×1536 of the obtained image to the resolution of 800×600 of the display unit 140.

In step S305, the storing module 3005 stores the adjusted image to the storage unit 120 of the digital photo frame 10.

In decision step S306, the obtaining module 3002 detects whether there is another image needed in the external memory 20 according to the sorting criteria in step S302. If there is another image needed, the procedure continues to step S307. If there is no another image needed, the procedure ends.

In step S307, the obtaining module 3003 obtains another desired image from the external memory 20 according to the sorting criteria, and then the procedure returns to decision step S303.

Although the present invention has been specifically described on the basis of exemplary embodiment thereof, the invention is not to be construed as being limited thereto. Various changes or modifications may be made to the embodiment without departing from the scope and spirit of the invention.

What is claimed is:

1. A display device comprising:
an interface for connecting with an adjusting device;
a display unit for displaying images;
an obtaining module capable of obtaining a source location, a target location, and a revolution of the display device, wherein the source location is a location where the images that needed to be adjusted are stored, and the target location is another location where the adjusted images will be stored;
a request generating module capable of generating an adjusting request including the source location, the target location, and the revolution of the display device; and
a sending module capable of sending the adjusting request and images from the source location to the adjusting device.

2. The display device according to claim 1, wherein the display device further comprises a detecting module capable of detecting whether the display device is connected with the adjusting device;

3. The display device according to claim 1, wherein the source location is an external memory connected with the display device or the storage unit in the display device.

4. The display device according to claim 1, wherein the target location is an external memory connected with the display device, or the storage unit in the display device.

5. The display device according to claim 1, wherein the display device further comprises a setting module capable of setting the source location and the target location.

6. An adjusting device connected with a display device, comprising:
an interface for receiving an adjusting request including a source location, a target location, and a revolution of the display device from the display device;
an information obtaining module capable of obtaining the source location, the target location and the revolution of the display device from the adjusting request, and obtaining images from the source location, wherein the source location is a location where the images that needed to be adjusted are stored, and the target location is another location where the adjusted images will be stored;
an adjusting module capable of reducing the resolution of the obtained image according to the resolution of the display device when a revolution of the obtained image is not consistent with the revolution of the display device; and
a storing module capable of storing the adjusted images to the target location.

7. The adjusting device according to claim 6, wherein the source location is an external memory connected with the display device, or a storage unit in the display device.

8. The adjusting device according to claim 6, wherein the target location is an external memory connected with the display device, or a storage unit in the display device.

9. An image adjusting method comprising:
supplying an adjusting device connected with a display device;
receiving an adjusting request including a source location, a target location and a revolution of the display device from the display device;
reducing the resolution of the obtained image according to the resolution of the display device when a revolution of the obtained image is not consistent with the revolution of the display device; and
storing the adjusted desired image to the target location.

10. The method according to claim 9, further comprising setting the source location and the target location.

11. The method according to claim 9, further comprising detecting whether the display device is connected with the adjusting device.
